(19) United States
(12) Patent Application Publication
(10) Pub. No.: US 2025/0206339 A1
(43) Pub. Date: Jun. 26, 2025

(54) AUTONOMOUS DRIVING VEHICLES AND METHODS FOR CONTROLLING THE SAME

(71) Applicants: Hyundai Motor Company, Seoul (KR); Kia Corporation, Seoul (KR)

(72) Inventor: Yea Bin Lee, Hwaseong-si (KR)

(21) Appl. No.: 18/962,202

(22) Filed: Nov. 27, 2024

(30) Foreign Application Priority Data
Dec. 20, 2023 (KR) 10-2023-0187293

(51) Int. Cl. B60W 60/00

(52) U.S. Cl. CPC B60W 60/001; B60W 2552/53; B60W 2555/60; B60W 2556/50

(57) ABSTRACT

An apparatus for controlling autonomous driving of a vehicle is introduced. The apparatus may comprise a GPS receiver, a memory storing a high-definition (HD) map, at least one sensor for sensing surroundings of the vehicle, and a processor. The processor is configured to estimate the vehicle's position based on GPS information, HD map information, and sensor information. The apparatus further determines one or more road boundaries based on a line of sight (LOS) condition, which is verified using the estimated position. A filtering target is selected from the road boundaries based on a reference boundary. A driving distance traveled by the vehicle is set periodically at predetermined intervals based on the filtering target. A signal associated with the periodically set driving distance is output, and autonomous driving of the vehicle is controlled based on the signal.

This application claims the benefit of Korean Patent Application No. 10-2023-0187293, filed in the Korean Intellectual Property Office on Dec. 20, 2023, the entire contents of which is incorporated herein by reference.

### TECHNICAL FILED

The present disclosure relates to an autonomous vehicle and a control method thereof.

### BACKGROUND

The matters described in this Background section are only for enhancement of understanding of the background of the disclosure, and should not be taken as acknowledgment that they correspond to prior art already known to those skilled in the art.

An autonomous vehicle refers to a vehicle that perceives its driving environment, determines risks, controls its driving route, and drives itself with minimal intervention from human drivers.

This autonomous vehicle is ultimately a vehicle capable of driving, operating, and parking itself without human influence, focusing on an autonomous driving technology, a core technology on which the vehicle is based, i.e., the most advanced state of its capability that may operate the vehicle itself without active control or monitoring by a driver.

However, the concept of the autonomous vehicle may involve an intermediate step of automation toward the concept of a fully automated or autonomous vehicle, which corresponds to a goal-oriented concept predicated on the mass production and commercialization of the fully autonomous vehicle.

According to the Society of Automotive Engineers (SAE), an American organization of automotive engineers, the automation levels of autonomous vehicles are categorized from level 0 to level 5.

Autonomous driving at level 4 and above is close to fully autonomous driving, but there may be limitations of lidar perception due to the shapes of road structures during driving in autonomous driving mode.

A lidar point is detected randomly within a lidar-perceivable height range. As a result, the lateral position of a lidar-perceived output line may be inaccurate depending on a cross-section.

For example, in a case where the shape of a median strip is not rectangular, and a lidar output line is output between two road boundaries, it may be matched to an outer road boundary by an iterative closest point (ICP) algorithm, which may reduce the accuracy of an estimated precision position of a vehicle.

### SUMMARY

According to the present disclosure, an apparatus for controlling autonomous driving of a vehicle, the apparatus may comprise, a global positioning system (GPS) receiver, a memory storing a high-definition (HD) map, at least one sensor configured to sense surroundings of the vehicle, and a processor configured to, estimate a position of the vehicle based on GPS information from the GPS receiver, HD map information from the memory, and sensor information from the at least one sensor, determine, based on a line of sight (LOS) condition being satisfied, one or more road boundaries, wherein the LOS condition being satisfied is determined based on the estimated position, determine, based on a reference boundary, one of the one or more road boundaries as a filtering target, set, based on the filtering target, a driving distance by which the vehicle has traveled, periodically at an interval of a predetermined driving distance, output a signal associated with the periodically set driving distance, and control, based on the signal, the autonomous driving of the vehicle.

The apparatus, wherein the LOS condition may comprise, a property condition to check whether the one or more road boundaries are of a same property, an area condition to check whether the sensor information is related to an area within a sensor-perceivable area, and a direction condition to check whether a direction of the vehicle is a lateral direction.

The apparatus, wherein the processor is further configured to maintain the filtering target, wherein the filtering target is determined in a previous frame as the filtering target for a current frame.

The apparatus, wherein the processor is further configured to, generate an LOS line, wherein the LOS line connects one point of one road boundary of the one or more road boundaries to the vehicle, and wherein the one point of the one road boundary of the one or more road boundaries is present within a sensor-perceivable area, and determine whether the generated LOS line intersects another road boundary of the one or more road boundaries.

The apparatus, wherein the processor is further configured to, determine a height difference between the one road boundary, determined as the filtering target, and the LOS line.

The apparatus, wherein the processor is further configured to, based on the height difference being greater than or equal to a threshold height, set an intersection point at which the generated LOS line intersects the other road boundary of the one or more road boundaries.

The apparatus, wherein the processor is further configured to, determine whether the intersection point is out of a threshold range.

The apparatus, wherein the processor is further configured to, determine a number of intersection points, and based on the number of intersection points being greater than or equal to a threshold number, set the filtering target.

The apparatus, wherein the sensor information may comprise at least one of, a lane marking, a road edge, a road mark, a traffic sign, a road sign, a stop line, or a crosswalk.

According to the present disclosure, a method performed by an apparatus for controlling autonomous driving of a vehicle, the method may comprise, estimating a position of the vehicle based on global positioning system (GPS) information, high-definition (HD) map information, and sensor information about surroundings of the vehicle, determining, based on a line of sight (LOS) condition being satisfied, one or more road boundaries, wherein the LOS condition being satisfied is determined based on the estimated position, determining, based on a reference boundary, one of the one or more road boundaries as a filtering target, setting, based on the filtering target, a driving distance by which the vehicle has traveled, periodically at an interval of a predetermined driving distance, outputting a signal associated with the periodically set driving distance, and controlling, based on the signal, the autonomous driving of the vehicle.

The method, wherein the LOS condition may comprise, a property condition to check whether the one or more road boundaries are of a same property, an area condition to check whether the sensor information is related to an area within a sensor-perceivable area, and a direction condition to check whether a direction of the vehicle is a lateral direction.

The method, may further comprise, maintaining the filtering target, wherein the filtering target is determined in a previous frame as the filtering target for a current frame.

The method, wherein the determining the one or more road boundaries as the filtering target may comprise, generating an LOS line, wherein the LOS line connects one point of one road boundary of the one or more road boundaries to the vehicle, and wherein the one point of the one road boundary of the one or more road boundaries is present within a sensor-perceivable area, and determining whether the generated LOS line intersects another road boundary of the one or more road boundaries.

The method, wherein the determining the one or more road boundaries as the filtering target may further comprise, determining a height difference between the road boundary, determined as the filtering target, and the LOS line.

The method, wherein the determining the one or more road boundaries as the filtering target may further comprise, based on the height difference being greater than or equal to a threshold height, setting an intersection point at which the generated LOS line intersects the other road boundary of the one or more road boundaries.

The method, wherein the determining the one or more road boundaries as the filtering target may further comprise, determining whether the intersection point is out of a threshold range.

The method, wherein the determining the one or more road boundaries as the filtering target may further comprise, determining a number of intersection points, and based on the number of intersection points being greater than or equal to a threshold number, setting the filtering target.

The method, wherein the sensor information may comprise at least one of, a lane marking, a road edge, a road mark, a traffic sign, a road sign, a stop line, or a crosswalk.

A non-transitory computer-readable storage medium storing a program that, when executed, is configured to cause, estimating a position of a vehicle based on global positioning system (GPS) information, high-definition (HD) map information, and sensor information about surroundings of the vehicle, determining, based on a line of sight (LOS) condition being satisfied, one or more road boundaries, wherein the LOS condition being satisfied is determined based on the estimated position, determining, based on a reference boundary, one of the one or more road boundaries as a filtering target, setting, based on the filtering target, a driving distance by which the vehicle has traveled, periodically at an interval of a predetermined driving distance, outputting a signal associated with the periodically set driving distance, and controlling, based on the signal, autonomous driving of the vehicle.

The non-transitory computer-readable storage medium, wherein the program, when executed, is configured to cause, generating an LOS line, wherein the LOS line connects one point of one road boundary of the one or more road boundaries to the vehicle, and wherein the one point of the one road boundary of the one or more road boundaries is present within a sensor-perceivable area, and determining whether the generated LOS line intersects another road boundary of the one or more road boundaries.

### BRIEF DESCRIPTION OF THE DRAWINGS

FIG. 1 shows an example of an autonomous vehicle according to an example of the present disclosure.

FIG. 2 shows an example of a method of controlling an autonomous vehicle according to an example of the present disclosure.

FIG. 3, FIG. 4, FIG. 5, FIG. 6, and FIG. 7 are examples of a method of filtering road boundaries in a HD map according to an example of the present disclosure.

FIG. 8A and FIG. 8B show an example of measurements obtained from a real road according to an example of the present disclosure.

FIG. 9A, FIG. 9B, and FIG. 9C show an example of measurements obtained from a real road according to another example of the present disclosure.

### DETAILED DESCRIPTION OF THE DISCLOSURE

Hereinafter, examples of the present disclosure will be described in detail with reference to the accompanying drawings, for a better understanding of the present disclosure. The examples are not construed as limited to the disclosure and should be understood to include all changes, equivalents, and replacements within the idea and the technical scope of the disclosure. The examples of the present disclosure are provided to more fully explain the gist of the disclosure to a person having ordinary skill in the art to which the present disclosure pertains.

In the description of the examples, when an element is described as formed “above/on” or “below/under” another element, it may be construed that the two elements are in direct contact, or they are in indirect contact with one or more other elements interposed therebetween.

In this case, the use of “above/on” or “below/under” may be based on what is shown in the accompanying drawings, and these terms are used only to indicate a relative positional relationship between elements but may not be used to limit the actual positions of the elements.

In addition, relational terms such as “first” and “second,” and “above/on/upper” and “below/under/lower” may be used to distinguish one element or entity from another, without necessarily requiring or implying any physical or logical relationship or order between such elements or entities.

Specifically, for purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Hereinafter, an autonomous vehicle capable of maintaining stability of precision positioning-based lateral position estimation by filtering map data processor (MDP) input data corresponding to all information within a transmitting area based on a lidar-perceivable area used for map matching, and a method of controlling the autonomous vehicle, will be described below with reference to the accompanying drawings.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of a filtering target) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of a filtering target) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of a filtering target) described herein.

Minimum risk maneuver (MRM) operation(s) may also be controlled, for example, based on one or more features (e.g., features of a filtering target) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of a filtering target) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of a filtering target) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

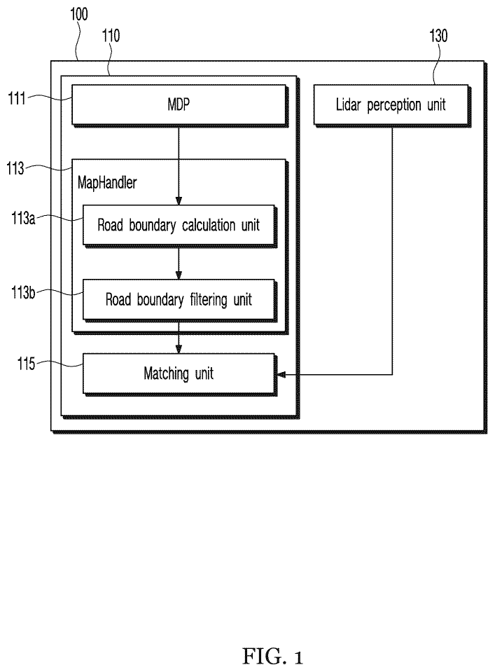

FIG. 1 shows an example of an autonomous vehicle according to an example of the present disclosure.

Referring to FIG. 1, according to an example of the present disclosure, an autonomous vehicle 100 may include a processor (e.g., an autonomous driving controller 110 implemented as circuit, circuitry, application specific integrated circuit (ASIC)) and a lidar perception unit 130. The autonomous vehicle 100 may also be referred to herein as an ego vehicle.

The autonomous driving controller 110 may include an integrated map data processor (MDP) 111, a map handler 113, and a matching unit 150. The autonomous driving controller 110 may also be referred to as an integrated autonomous driving controller.

The autonomous driving controller 110 may receive global positioning system (GPS) information provided by a connected car integrated cockpit (ccIC) controller (not shown) and HD map information provided by a HD map server to determine whether such input data is valid. In this case, the GPS information may be received by an antenna mounted on the ego vehicle from a plurality of artificial satellites within a transmissible/receivable distance from the ego vehicle, input to the ccIC controller, and provided to the autonomous driving controller 110 by the ccIC controller.

The autonomous driving controller 110 may estimate a position of the autonomous vehicle 100 using the GPS information, the HD map information, and sensor information, and may determine whether a line of sight (LOS) application condition is satisfied based on the estimated position of the autonomous vehicle 100. LOS may be used to describe a visibility line or path that connects the vehicle's position to one or more road boundaries. It may be a part of a system that checks or filters road boundaries to ensure they are within a clear line of sight from the vehicle, which is useful for autonomous driving systems to accurately perceive and navigate their surroundings. The LOS line may help determine which road boundaries are relevant based on their visibility to the vehicle's sensors within a sensor-perceivable area.

For example, if the LOS application condition is satisfied, the autonomous driving controller 110 may determine one or more road boundaries with respect to the position of the autonomous vehicle 100, analyze and compare the determined one or more road boundaries to a predetermined reference boundary to determine a filtering target to be filtered. A filtering target may be a road boundary that has been singled out for further processing, allowing the autonomous driving controller 110 to focus on relevant boundaries while ignoring others, thereby enhancing the accuracy and reliability of autonomous vehicle control. The filtering target may correspond to specific road boundaries selected for processing or analysis. These boundaries may be chosen based on certain criteria, such as their relevance to the vehicle's current position, their visibility within the line of sight (LOS), and their sensor-detectable properties. The filtering target is determined by applying various LOS conditions, including property checks, area checks, and direction checks, to identify boundaries that meet the necessary conditions for safe and accurate navigation.

The autonomous driving controller 110 may also estimate the position of the autonomous vehicle 100 by itself using a GPS position from the ccIC controller, and may process and transmit the HD map information about its vicinity.

The autonomous driving controller 110 may also estimate the position of the autonomous vehicle 100 using a GPS position, ccIC driving path, and precision positioning result from a high-definition map (HDM), and may process necessary information.

However, examples are not limited thereto, and any module disposed in the autonomous vehicle 100 that transmits/receives the HD map information may estimate the position of the autonomous vehicle 100 at a time each module performs computation or operations under the control of the autonomous driving controller 110.

The integrated MDP 111 may generate HD map information including, for example, roads, lanes, facilities, and the like, in the vicinity of the autonomous vehicle 100 (or the ego vehicle) that is traveling on a road or is at rest, under the control of the autonomous driving controller 110. A HD map described herein may include various road data required for autonomous driving, such as, for example, precisely constructed lanes, traffic lights, signs, and the like.

For example, the HD map may include the road data or the HD map information including information about the height, curvature, and slope of the road, lanes, road facilities, information about various changes to the road, and the like. For example, the HD map information may include road/lane property information, road/lane geometry information, road/lane facility information, MDP fail information, and the like, which are associated with the road.

The integrated MDP 111 may detect and analyze real-time road information and the like through the autonomous vehicle 100 that is traveling on the road or is at rest, and may then receive a corresponding most recent HD map, under the control of the autonomous driving controller 110.

For example, under the control of the autonomous driving controller 110, the integrated MDP 111 may receive information by the antenna mounted on the ego vehicle from a plurality of artificial satellites within a transmissible/receivable distance from the ego vehicle and input the received information into the ccIC controller, and the ccIC controller may receive, in real time, the most recent HD map within a predetermined GPS range based on the GPS information provided by the autonomous driving controller 110. That is, the integrated MDP 111 may receive the GPS information and the HD map information processed based on the GPS information, under the control of the autonomous driving controller 110. The processed HD map information described above may be HD map information about an area that is separated by a predetermined distance based on the GPS information.

The integrated MDP 111 may receive the HD map information related to the surroundings in the GPS information based on the GPS information, which may significantly reduce a data quantity of the HD map information to facilitate real-time data transmission.

The map handler 113 may receive and analyze the HD map information provided by the integrated MDP 111 and/or the GPS information and navigation map information provided by a navigation controller (not shown), and may estimate a precision positioning-based position based on a resulting analysis value obtained by the analyzing, under the control of the autonomous driving controller 110.

The map handler 113 may include a road boundary calculation unit 113a and a road boundary filtering unit 113b.

The map handler 113 may estimate the position of the autonomous vehicle 100 using the GPS information and the HD map information, and may determine whether the LOS application condition is satisfied based on the estimated position of the autonomous vehicle 100, under the control of the autonomous driving controller 110.

In response to the LOS application condition being satisfied, the map handler 113 may determine one or more road boundaries with respect to the position of the autonomous vehicle 100, and may analyze and compare at least one of the determined one or more road boundaries to a predetermined reference boundary to determine a filtering target, under the control of the autonomous driving controller 110.

For example, in response to the LOS application condition being satisfied, the road boundary calculation unit 113a may determine one or more road boundaries with respect to the position of the autonomous vehicle 100, under the control of the autonomous driving controller 110. This will be described in more detail below.

The road boundary filtering unit 113b may analyze and compare at least one of the determined one or more road boundaries to the predetermined reference boundary to determine whether the filtering target, under the control of the autonomous driving controller 110. This will be described in more detail below.

The matching unit 115 may match the determined filtering target to the sensor information provided via the lidar perception unit 130 to accurately output a lateral position of a lidar output line that is not accurate along a cross-section, under the control of the autonomous driving controller 110.

The matching unit 115 may also match the determined filtering target to the sensor information provided via the lidar perception unit 130 to reduce a long-distance output error between a road with a large curvature and a road with a small curvature, under the control of the autonomous driving controller 110.

The autonomous driving controller 110 described above may control at least one other component (e.g., a hardware component (e.g., an interface and/or memory) and/or a software component (e.g., a software program))), and may perform various data processing and computations.

The autonomous driving controller 110 may also be referred to as a processor, a controller, a control unit, a control circuit, and the like.

The autonomous driving controller 110 may also include, although not shown, a memory. The memory may store therein various data used by the autonomous driving controller 110, the integrated MDP 111, the map handler 113, and the lidar perception unit 130, for example, input data and/or output data for software programs and commands associated therewith.

The memory may include a non-volatile memory such as cache, read-only memory (ROM), programmable ROM (PROM), erasable programmable ROM (EPROM), electrically erasable programmable ROM (EEPROM), and/or flash memory, and/or a volatile memory such as random-access memory (RAM).

The lidar perception unit 130 may recognize at least one set of sensor information and provide the recognized sensor information to the autonomous driving controller 110. The sensor information may include, as non-limiting examples, lane markings, nearby lane markings, road edges, road markings, traffic signs, road signs, stop lines, crosswalks, and the like.

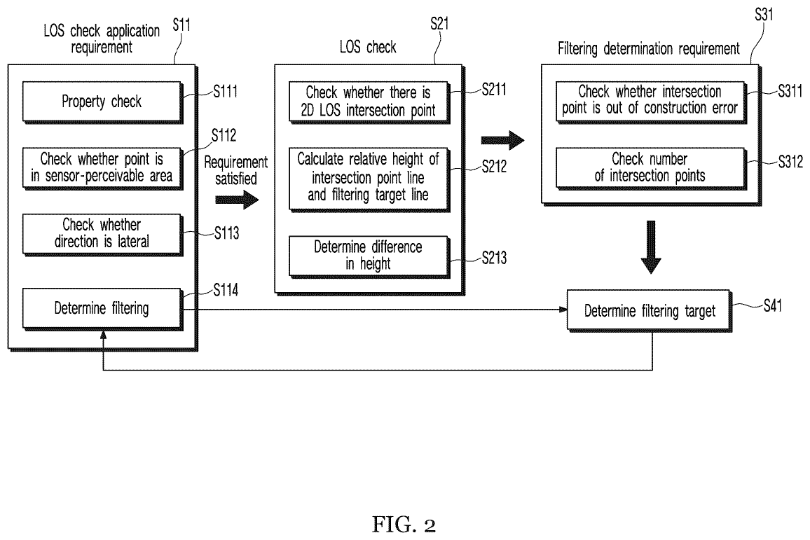

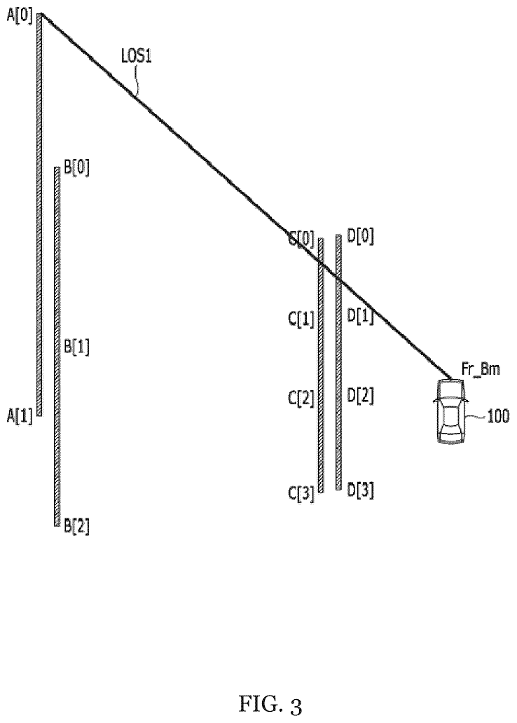

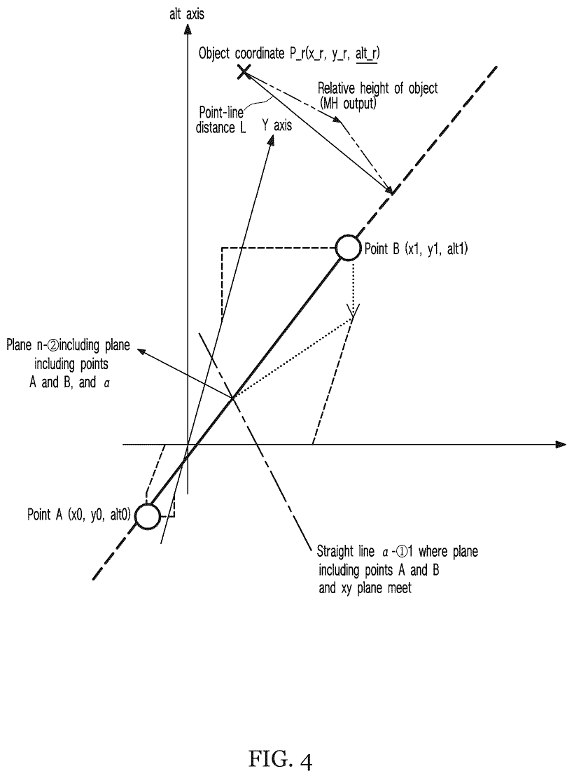

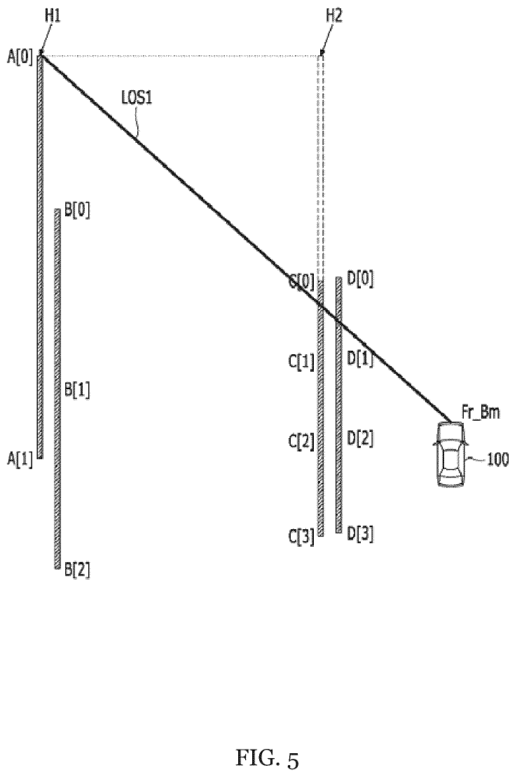

FIG. 2 shows an example of a method of controlling an autonomous vehicle according to an example of the present disclosure. FIGS. 3 through 7 are examples of a method of filtering road boundaries in a HD map according to an example of the present disclosure. For convenience, FIG. 2 is described by way of an example in which the steps are performed by a processor (e.g., control circuitry). One, some, or all steps of FIG. 2, or portions thereof, may be performed by one or more other circuits. One or some, steps of FIG. 2 may be omitted, performed in other orders, and/or otherwise modified, and/or one or more additional steps may be added.

Referring to FIG. 2, FIG. 3, FIG. 4, FIG. 5, FIG. 6, and FIG. 7, according to an example of the present disclosure, an autonomous vehicle may operate as follows.

In step S11, the autonomous vehicle 100 may estimate a position of the autonomous vehicle 100 using GPS information, HD map information, and sensor information, and may determine whether an LOS application condition is satisfied based on the estimated position of the autonomous vehicle 100, under the control of the autonomous driving controller 110.

For example, the autonomous vehicle 100 may apply the LOS application condition, under the control of the autonomous driving controller 110. The LOS application condition may also be referred to as a LOS check algorithm application condition.

The LOS application condition may include a property check, an area check, a direction check, and a temporal continuity check.

The property check may check whether one or more road boundaries are of the same property (S111). For example, the property check may check whether two road boundaries have the same property. In this case, if the two road boundaries have the same property, the LOS application condition may be satisfied.

The area check may check whether an area is within a sensor-perceivable area that covers the sensor information (S112). The area check may also be referred to as a sensor-perceivable area check.

For example, the area check may check whether a point is a point (or dot) constructed within the sensor-perceivable area. In this case, if the point is out of the area, the area check may interpolate x, y, height, and the like to a point 80 meters ahead and 60 meters behind, under the control of the autonomous driving controller 110. If it is satisfied by the area check, the LOS application condition may be determined to be satisfied.

The direction check may check whether a direction of the autonomous vehicle is lateral (S113). In this case, the direction check may affect the performance of estimating a longitudinal position if a longitudinal direction is missing. For example, when the direction of the autonomous vehicle is checked as lateral by the direction check, the LOS application condition may be determined to be satisfied.

If the three conditions—the property check, the area check, and the direction check described above—are all satisfied, the autonomous vehicle 100 may determine the filtering target, under the control of the autonomous driving controller 110.

Additionally, if the temporal continuity check is additionally satisfied after the three conditions are satisfied, the determining of the filtering target may be performed (S114). In this case, the temporal continuity check may be performed, and if a previous frame includes a filtering target on at least one road boundary, the road boundary which is the filtering target may be maintained in a current frame.

That is, in step S41, the autonomous vehicle 100 may check whether there is a filtering target in a previous frame, and when the filtering target is checked, may select or determine the filtering target in the previous frame to be a filtering target also in a current frame, under the control of the autonomous driving controller 110.

In this case, the autonomous driving vehicle 100 may periodically initialize the distance once for every predetermined driving distance, under the control of the autonomous driving controller 110. The predetermined driving distance may be approximately 30 meters (m).

In step S21, if the LOS check algorithm application condition is satisfied, the autonomous vehicle 100 may apply a LOS check algorithm, under the control of the autonomous driving controller 110.

If the LOS application condition is satisfied, the autonomous vehicle 100 may determine one or more road boundaries with respect to the position of the autonomous vehicle 100, under the control of the autonomous driving controller 110. That is, in step S211, the autonomous vehicle 100 may check whether there is a two-dimensional (2D) LOS intersection point if the LOS application condition is satisfied, under the control of the autonomous driving controller 110. For example, the autonomous vehicle 100 may perform the check on all the road boundaries, under the control of the autonomous controller 110.

As shown in FIG. 3, the autonomous vehicle 100 may determine one or more road boundaries and generate an LOS line that connects the autonomous vehicle 100 to a point on one of the road boundaries present within the sensor-perceivable area based on the position of the autonomous vehicle 100, under the control of the autonomous controller 110. For example, the autonomous vehicle 100 may generate a LOS line (LOS1), which is a line connecting a point (e.g., A[0], A[1], . . . ) within a range of all the road boundaries and the position of the autonomous vehicle 100, under the control of the autonomous driving controller 110. In this case, the position of the autonomous vehicle 100 may be based on a lidar-mounted position (e.g., a front bumper Fr_Bm).

That is, the LOS line, LOS1, may be a line connecting a point (e.g., A[0], A[1], . . . ) within a road boundary area range and the lidar-mounted position (e.g., a front bumper).

In step S211, the autonomous vehicle 100 may then determine whether there is an intersection point at which the generated LOS line intersects another road boundary among the one or more road boundaries, under the control of the autonomous driving controller 110. For example, the autonomous vehicle 100 may check whether the generated LOS line intersects the other road boundary, under the control of the autonomous driving controller 110.

In this case, the autonomous vehicle 100 may use a counterclockwise (CCW) algorithm to check or determine whether the LOS line intersects the other road boundary, under the control of the autonomous driving controller 110. The CCW algorithm is well known in the art and will be described briefly without further explanation.

For example, the CCW algorithm may check a rotation in a clockwise/counterclockwise direction. That is, when, for points P1 (x1, y1), P2 (x2, y2), P3 (x3, y3), and P4 (x4, y4), CCW(P1, P2, P3)=(x2−x1)(y3−y1)−(y2−y1)(x3−x1), a positive CCW value may be output when the point P3 rotates counterclockwise relative to the points P1 and P2, and a negative CCW value may be output when it rotates clockwise.

The CCW algorithm may check whether there is an intersection point between two lines based on the foregoing. For example, CCW(P1, P2, P3)*CCW(P1, P2, P4)<0, and CCW (P3, P4, P1)*CCW (P3, P4, P2)<0.

For example, as shown in FIG. 3, when comparing the LOS line to a road boundary B, the LOS line may not intersect the road boundary B. This may be expressed as CCW1<0 (P1, P2, P3), CCW2<0 (P1, P2, P4), CCW3<0 (P3, P4, P1), and CCW4>0 (P3, P4, P2).

In contrast, as shown in FIG. 3, when comparing the LOS line to a road boundary C, the LOS line may intersect the road boundary C. This may be expressed as CCW1>0 (P1, P2, P3), CCW2<0 (P1, P2, P4), CCW3>0 (P3, P4, P1), and CCW4<0 (P3, P4, P2).

In step S212, the autonomous vehicle 100 may then determine a relative height between the LOS line and a road boundary which is the filtering target, under the control of the autonomous driving controller 110. For example, the autonomous vehicle 100 may determine a relative height between an intersection line and a filtering target line, under the control of the autonomous driving controller 110.

As shown in FIG. 4, the autonomous vehicle 100, may determine a relative height according to a definition of a plane, under the control of the autonomous driving controller 110.

In this case, a premise is that a constructed altitude (alt) may be a height perpendicular to an xy plane, and a relative height to be output may be a height perpendicular to a plane of an ego vehicle.

In this case, the conditions for determining the plane of the ego vehicle are as follows.

\textcircled{1} There is a straight line passing through point A and point B.

\textcircled{2} An intersection line a (alpha) of a relative coordinate xy plane and the plane of the ego vehicle is perpendicular to the straight line passing through the points A and B. By the condition \textcircled{2}, a normal vector n of the plane may be determined.

The autonomous vehicle 100 may determine the relative height based on the definition of the plane as follows, under the control of the autonomous driving controller 110.

First, a direction vector that is simultaneously perpendicular to (x1−x0, y1−y0, alt(0)) and (0, 0, 1) may be expressed as, A=(y1−y0, −(x1−x0), 0).

Subsequently, a normal vector n of the plane that is simultaneously perpendicular to a (alpha) and (x1−x0, y1−y0, alt1−alt0) may be expressed as, N=(x1−x0, y1−y0, −((x1−x0)+(y1−y0)*(y1−y0))/(alt1−alt0)). This may be a normal vector of the plane of the ego vehicle.

Subsequently, H may be a distance between the point P_r (x_r, yr, alt_r) and the plane n*(x−x0, y−y0, a1−alt(0))=0.

Subsequently, in step S213, as shown in FIGS. 5 through 7, the autonomous vehicle 100 may set an intersection point if the relative height is greater than or equal to the predetermined threshold height, under the control of the autonomous driving controller 110. That is, the autonomous vehicle 100 may determine the relative height of the intersection point line and the filtering target line, under the control of the autonomous driving controller 110.

The autonomous vehicle 100 may analyze and compare at least one of the determined one or more road boundaries to the predetermined reference boundary to determine the filtering target, under the control of the autonomous driving controller 110.

As shown in FIG. 5, the autonomous vehicle 100 may determine a relative height H1 of a sight point of a LOS, under the control of the autonomous driving controller 110. The sight point of the LOS may be a reference boundary, and may also be referred to herein as a road boundary A.

The autonomous vehicle 100 may determine a relative height H2 of a road boundary C that intersects the LOS line, under the control of the autonomous driving controller 110.

The autonomous vehicle 100 may compare the relative heights H1 and H2 to obtain a difference therebetween, and in response to the difference being less than a predetermined threshold, may select the intersection point, under the control of the autonomous driving controller 110.

For example, the predetermined threshold may be [30] centimeters (cm). Accordingly, in response to the difference between the relative heights H1 and H2 being less than [30] cm, the autonomous vehicle 100 may select a significant intersection point, under the control of the autonomous driving controller 110.

Referring to FIG. 6, under the control of the autonomous driving controller 110, the autonomous vehicle 100 may determine the relative height H2, when a lateral position of the sight point of the LOS is inside the road boundary C (e.g., inside the line) using Equation 1 below.

$$H 2 = \frac{( y - {y}_{2} ) {y}_{1} + ( {y}_{1} - y ) {y}_{2}}{( y - {y}_{2} ) + ( {y}_{1} - y )} \qquad [ Equation 1 ]$$

where, H1=a relative height of A[0], which may be expressed as S(x,y). Also, H2=an interpolated relative height of the road boundary C. Here, one point of the road boundary C may be expressed as A(x1, y1), and another point of the road boundary C may be expressed as B(x2, y2).

In this case, the autonomous vehicle 100 may internally divide y by a height ratio that cuts y1 and y2, under the control of the autonomous driving controller 110.

Referring to FIG. 7, under the control of the autonomous driving controller 110, the autonomous vehicle 100 may determine the relative height H2 when the lateral position of the sight point of the LOS is outside the road boundary C (e.g., outside the line) using Equation 2 below.

$$H 2 = \frac{( y - {y}_{2} ) {y}_{1} - ( y - {y}_{1} ) {y}_{2}}{( y - {y}_{2} ) - ( y - {y}_{1} )} \qquad [ Equation 2 ]$$

where, H1=a relative height of A[0], which may be expressed as S(x,y). H2=an interpolated relative height of the road boundary C. Here, one point of the road boundary C may be expressed as A(x1, y1), and another point of the road boundary C may be expressed as B(x2, y2).

In this case, the autonomous vehicle 100 may externally divide y by a height ratio that cuts y1 and y2, under the control of the autonomous driving controller 110.

Referring back to FIG. 2, in step S31, the autonomous vehicle 100 determine whether a filtering determination condition is satisfied, under the control of the autonomous driving controller 110. The filtering determination condition is as follow.

In step S311, the autonomous vehicle 100 may determine whether the intersection point is out of a construction error range, under the control of the autonomous driving controller 110.

In this case, the autonomous vehicle 100 may preferably determine an intersection point that is present further than the construction error range of a connected road boundary, under the control of the autonomous driving controller 110. The construction error range may be approximately 20 cm, for example.

The autonomous vehicle 100 may also determine the number of intersection points, under the control of the autonomous driving controller 110. In response to the determined number of intersection points being greater than or equal to a predetermined number, the autonomous vehicle 100 may set the filtering target (S31), under the control of the autonomous driving controller 110. The predetermined number may be two, for example.

For example, the autonomous driving vehicle 100 may be preferably determine the number of intersection points between the filtering target and a comparing target to be two or more, under the control of the autonomous driving controller 110.

The autonomous vehicle 100 may maintain the stability of estimating a lateral position in precise positioning by determining the filtering target, as described above, under the control of the autonomous driving controller 110.

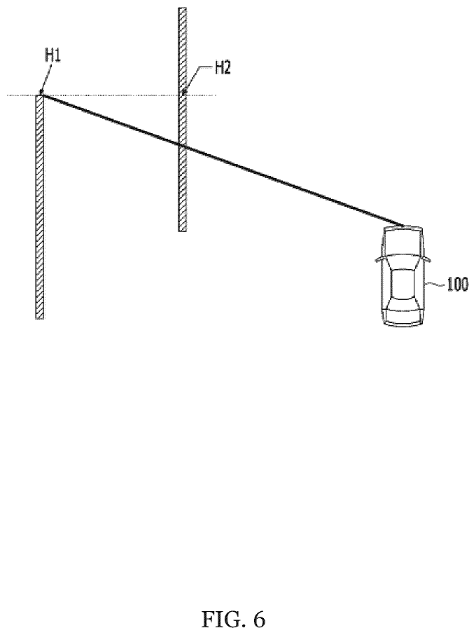

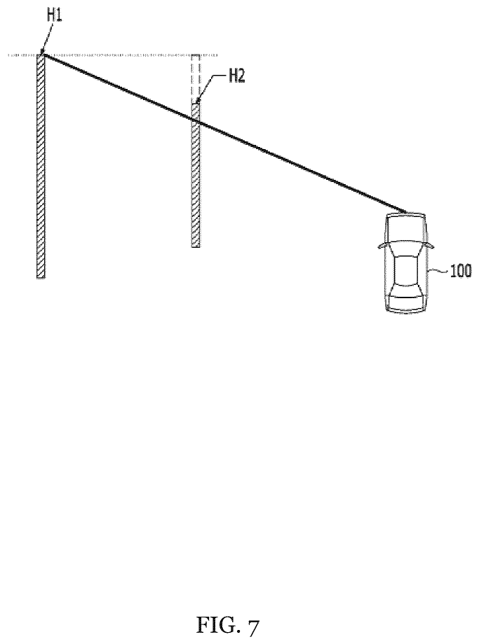

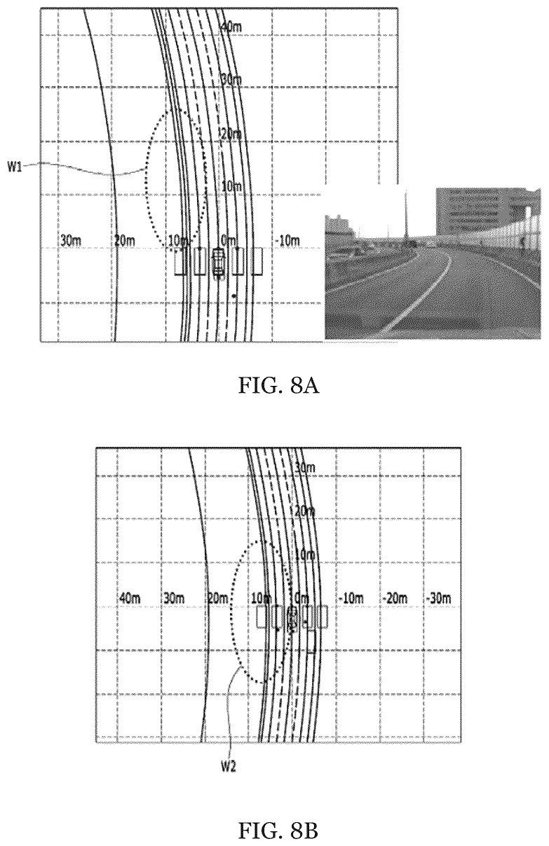

FIG. 8A and FIG. 8B show an example of measurements obtained from a real road according to an example of the present disclosure.

In FIG. 8A shows a cause of an issue on a real road, which may indicate that a matching pair is incorrectly selected, as shown in W1, where an outer barrier is partially sensed and matched, when in fact only an inner barrier sensor is output.

In this case, a road boundary map-matching position is estimated to be left-biased, but a vehicle is traveling while leaning rightward in the real world. Accordingly, it may be very likely to cause the driver to feel dangerous.

In contrast, FIG. 8B shows an improvement according to an example of the present disclosure, where all sensor data is matched to the inner barrier, as shown in W2.

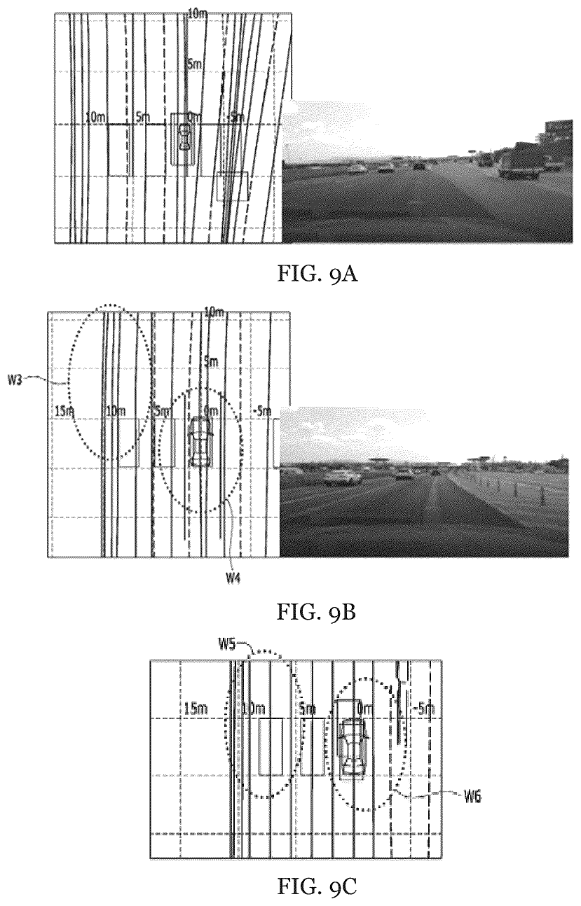

FIG. 9A, FIG. 9B, and FIG. 9C show an example of measurements obtained from a real road according to another example of the present disclosure.

FIG. 9A and FIG. 9B show a cause of an issue on a real road. For example, FIG. 9A shows a situation where there are no lanes available for lane map-matching, and FIG. 9B shows a situation where a matching pair is incorrectly selected, as indicated by W3, where all are on an outer barrier, although a lidar sensor recognizes an inner barrier in a real world. It may thus be a cause of erroneous determination of right-biased driving as a position of an ego vehicle is determined as being further to the left than it actually is, as indicated by W4.

As described above, as shown in FIG. 9A and FIG. 9B, lane map-matching position-based correction may not be available due to the absence of lanes on the road, and there is no map-matching criterion. Thus, in this case, the vehicle is traveling only by dead reckoning (DR, a technique for estimating a position by determining a starting position and speed), resulting in a left-biased positioning error. In addition, the lidar sensor may be matched to the outer barrier and may thereby be left-biased in positioning, and the vehicle may travel close by a visual guidance rod on the right side on the real road. Accordingly, this may cause the driver to feel dangerous and release the control, which may, in turn, cause a high risk of an accident.

In contrast, FIG. 9C shows an improvement according to an example of the present disclosure, where all sensor data is matched to the inner barrier, as indicated by W5 and W6.

As described above, if the LOS application condition is satisfied, the autonomous vehicle 100 may determine one or more road boundaries with respect to a position of the autonomous vehicle 100, and then analyze and compare at least one of the determined one or more road boundaries to a predetermined reference boundary to determine whether it is a filtering target to be filtered, under the control of the autonomous driving controller 110.

The autonomous driving controller 110 may be a processor (e.g., a central processing unit (CPU)) or a semiconductor device that processes instructions stored in a memory and/or a storage. The memory and the storage may include various types of volatile or non-volatile storage media. For example, the memory may include a read only memory (ROM) and a random access memory (RAM).

Accordingly, the operations of the method or algorithm described in connection with the examples disclosed in the specification may be directly implemented with a hardware module, a software module, or a combination of the hardware module and the software module, which is executed by the processor. The software module may reside on a storage medium (that is, the memory and/or the storage) such as a RAM, a flash memory, a ROM, an EPROM, an EEPROM, a register, a hard disc, a removable disk, and a CD-ROM.

The exemplary storage medium may be coupled to the processor. The processor may read out information from the storage medium and may write information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

An object of the present disclosure is to provide an autonomous vehicle and a control method thereof that may promote the reliability of precision positioning by maintaining a road boundary object in a sensor-perceivable range but removing others.

Another object of the present disclosure is to provide an autonomous vehicle and a control method thereof that may promote the reliability of precision positioning by performing filtering based on the height of a structure because, in a case where an outer road boundary of the structure is higher, despite the same road boundary property, a sensor may perceive both.

According to an example of the present disclosure, there is provided an autonomous vehicle including a global positioning system (GPS) receiver, a memory storing high-definition (HD) map, at least one sensor configured to sense surrounding of the autonomous vehicle, and an autonomous driving controller configured to control autonomous driving of the autonomous vehicle, wherein the autonomous driving controller is further configured to estimate a position of the autonomous vehicle using GPS information from the GPS receiver, HD map information of the memory, and sensor information sensed by the at least one sensor, based on determining that a line of sight (LOS) application condition is satisfied based on the estimated position, determine one or more road boundaries, determine one of the one or more road boundaries as a filtering target based on a predetermined reference boundary, and initialize a driving distance by which the autonomous vehicle has traveled, periodically at an interval of a predetermined driving distance, to control the autonomous driving of the autonomous vehicle.

The LOS application condition may include: a property check to check whether the one or more road boundaries are of the same property, an area check to check whether the sensor information is related to an area within a sensor-perceivable area, and a direction check to check whether a direction of the autonomous vehicle is a lateral direction.

The autonomous driving controller may be further configured to maintain a filtering target determined in a previous frame as a filtering target for a current frame.

The autonomous driving controller may be configured to generate an LOS line that connects one point of one road boundary of the one or more road boundaries present within the sensor-perceivable area and the autonomous vehicle, and determine whether there is an intersection point at which the generated LOS line intersects another road boundary of the one or more road boundaries.

The autonomous driving controller may be configured to determine a relative height between the road boundary, which is determined as the filtering target, and the LOS line.

The autonomous driving controller may be configured to: in response to the relative height being greater than or equal to a predetermined threshold height, set the intersection point.

The autonomous driving controller may be configured to: determine whether the intersection point is out of a predetermined range.

The autonomous driving controller may be configured to determine a number of intersection points and in response to the number of intersection points being greater than or equal to a predetermined number, set the filtering target.

The sensor information may include: one or more of a lane marking, a nearby lane marking, a road edge, a road mark, a traffic sign, a road sign, a stop line, or a crosswalk.

According to an example of the present disclosure, there is provided a method of controlling an autonomous vehicle, the method including estimating, by an autonomous driving controller, a position of the autonomous vehicle using global positioning system (GPS) information, high-definition (HD) map information, and sensor information about surroundings of the autonomous vehicle, based on determining that a line of sight (LOS) application condition is satisfied based on the estimated position, determining one or more road boundaries, determining one of the one or more road boundaries as a filtering target based on a predetermined reference boundary, and initializing a driving distance by which the autonomous vehicle has traveled, periodically at an interval of a predetermined driving distance, to control driving of the autonomous vehicle.

The LOS application condition may include a property check to check whether the one or more road boundaries are of the same property, an area check to check whether the sensor information is related to an area within a sensor-perceivable range, and a direction check to check whether a direction of the autonomous vehicle is a lateral direction.

The autonomous driving controller may be further configured to maintain a filtering target determined in a previous frame as a filtering target for a current frame.

The determining of the one or more road boundaries as the filtering target comprises generating an LOS line that connects one point of one road boundary of the one or more road boundaries present within the sensor-perceivable area and the autonomous vehicle, and determining whether there is an intersection point at which the generated LOS line intersects another road boundary of the one or more road boundaries.

The determining of the one or more road boundaries as the filtering target may further include determining a relative height between the road boundary, which is determined as the filtering target, and the LOS line.

The determining of the one or more road boundaries as the filtering target may further include in response to the relative height being greater than or equal to a predetermined threshold height, setting the intersection point.

The determining of the one or more road boundaries as the filtering target may further include determining whether the intersection point is out of a predetermined range.

The determining of the one or more road boundaries as the filtering target may further include determining a number of intersection points, and in response to the number of intersection points being greater than or equal to a predetermined number, setting the filtering target.

The sensor information may include: one or more of a lane marking, a nearby lane marking, a road edge, a road mark, a traffic sign, a road sign, a stop line, or a crosswalk.

The autonomous vehicle and the control method configured as described above according to examples of the present disclosure may promote the reliability of precision positioning by maintaining a road boundary object in a sensor-perceivable range but removing others.

Also, as an example of the present disclosure, there is provided a non-transitory computer-readable storage medium storing a program for executing the method described above.

The autonomous vehicle and the control method configured as described above according to examples of the present disclosure may also promote the reliability of precision positioning by performing filtering based on the height of a structure because, in a case where an outer road boundary of the structure is higher, despite the same road boundary property, a sensor may perceive both.

The autonomous vehicle and the control method configured as described above according to examples of the present disclosure may improve the reliability of the autonomous vehicle by maintaining a road boundary object in a sensor-perceivable range but removing others.

Meanwhile, a non-transitory computer-readable recording medium recording therein a program for executing the method of controlling the autonomous vehicle 100 according to an example of the present disclosure may record the program implementing the related functions, and a computer may read the recording medium.

The computer-readable medium may include all types of recording devices that store data to be read by a computer system. The computer-readable medium may include, for example, a hard disk drive (HDD), a solid-state drive (SSD), a silicon disk drive (SDD), a read-only memory (ROM), a random-access memory (RAM), a compact disc ROM (CD-ROM), a magnetic tape, a floppy disk, an optical data storage device, and the like. In addition, computer-readable recording media may be distributed across networked computer systems, such that computer-readable code may be stored and executed in a distributed manner. Also, functional programs, code, and code segments for implementing the method may be readily inferred by programmers of ordinary skill in the art to which the present disclosure pertains.

The various examples described herein may be combined with each other without departing from the objectives of the present disclosure, provided they are not inconsistent with each other. Furthermore, if a component of any of the various examples described herein is not described in detail, the description of a component having the same reference numeral in another example may be incorporated therefrom.

Accordingly, the preceding detailed description should not be construed as restrictive but as illustrative in all respects. The scope of the examples of the present disclosure should be determined by reasonable interpretation of the appended claims, and all changes and modifications within the equivalent scope of the present disclosure are included in the scope of the present disclosure.

What is claimed is:

1. An apparatus for controlling autonomous driving of a vehicle, the apparatus comprising:
a global positioning system (GPS) receiver;
a memory storing a high-definition (HD) map;
at least one sensor configured to sense surroundings of the vehicle; and
a processor configured to:
estimate a position of the vehicle based on GPS information from the GPS receiver, HD map information from the memory, and sensor information from the at least one sensor;
determine, based on a line of sight (LOS) condition being satisfied, one or more road boundaries, wherein the LOS condition being satisfied is determined based on the estimated position;
determine, based on a reference boundary, one of the one or more road boundaries as a filtering target;
set, based on the filtering target, a driving distance by which the vehicle has traveled, periodically at an interval of a predetermined driving distance;
output a signal associated with the periodically set driving distance; and
control, based on the signal, the autonomous driving of the vehicle.

2. The apparatus of claim 1, wherein the LOS condition comprises:
a property condition to check whether the one or more road boundaries are of a same property;
an area condition to check whether the sensor information is related to an area within a sensor-perceivable area; and
a direction condition to check whether a direction of the vehicle is a lateral direction.

3. The apparatus of claim 1, wherein the processor is further configured to maintain the filtering target, wherein the filtering target is determined in a previous frame as the filtering target for a current frame.

4. The apparatus of claim 1, wherein the processor is further configured to:
generate an LOS line, wherein the LOS line connects one point of one road boundary of the one or more road boundaries to the vehicle, and wherein the one point of the one road boundary of the one or more road boundaries is present within a sensor-perceivable area; and
determine whether the generated LOS line intersects another road boundary of the one or more road boundaries.

5. The apparatus of claim 4, wherein the processor is further configured to:
determine a height difference between the one road boundary, determined as the filtering target, and the LOS line.

6. The apparatus of claim 5, wherein the processor is further configured to:
based on the height difference being greater than or equal to a threshold height, set an intersection point at which the generated LOS line intersects the other road boundary of the one or more road boundaries.

7. The apparatus of claim 6, wherein the processor is further configured to:
determine whether the intersection point is out of a threshold range.

8. The apparatus of claim 7, wherein the processor is further configured to:
determine a number of intersection points; and
based on the number of intersection points being greater than or equal to a threshold number, set the filtering target.

9. The apparatus of claim 1, wherein the sensor information comprises at least one of:
a lane marking,
a road edge,
a road mark,
a traffic sign,
a road sign,
a stop line, or
a crosswalk.

10. A method performed by an apparatus for controlling autonomous driving of a vehicle, the method comprising:
estimating a position of the vehicle based on global positioning system (GPS) information, high-definition (HD) map information, and sensor information about surroundings of the vehicle;
determining, based on a line of sight (LOS) condition being satisfied, one or more road boundaries, wherein the LOS condition being satisfied is determined based on the estimated position;
determining, based on a reference boundary, one of the one or more road boundaries as a filtering target;
setting, based on the filtering target, a driving distance by which the vehicle has traveled, periodically at an interval of a predetermined driving distance;
outputting a signal associated with the periodically set driving distance; and
controlling, based on the signal, the autonomous driving of the vehicle.

11. The method of claim 10, wherein the LOS condition comprises:
a property condition to check whether the one or more road boundaries are of a same property;
an area condition to check whether the sensor information is related to an area within a sensor-perceivable area; and
a direction condition to check whether a direction of the vehicle is a lateral direction.

12. The method of claim 11, further comprising:
maintaining the filtering target, wherein the filtering target is determined in a previous frame as the filtering target for a current frame.

13. The method of claim 10, wherein the determining the one or more road boundaries as the filtering target comprises:
generating an LOS line, wherein the LOS line connects one point of one road boundary of the one or more road boundaries to the vehicle, and wherein the one point of the one road boundary of the one or more road boundaries is present within a sensor-perceivable area; and
determining whether the generated LOS line intersects another road boundary of the one or more road boundaries.

14. The method of claim 13, wherein the determining the one or more road boundaries as the filtering target further comprises:
determining a height difference between the road boundary, determined as the filtering target, and the LOS line.

15. The method of claim 14, wherein the determining the one or more road boundaries as the filtering target further comprises:
based on the height difference being greater than or equal to a threshold height, setting an intersection point at which the generated LOS line intersects the other road boundary of the one or more road boundaries.

16. The method of claim 15, wherein the determining the one or more road boundaries as the filtering target further comprises:
determining whether the intersection point is out of a threshold range.

17. The method of claim 16, wherein the determining the one or more road boundaries as the filtering target further comprises:
determining a number of intersection points; and
based on the number of intersection points being greater than or equal to a threshold number, setting the filtering target.

18. The method of claim 10, wherein the sensor information comprises at least one of:
a lane marking,
a road edge,
a road mark,
a traffic sign,
a road sign,
a stop line, or
a crosswalk.

19. A non-transitory computer-readable storage medium storing a program that, when executed, is configured to cause:
estimating a position of a vehicle based on global positioning system (GPS) information, high-definition (HD) map information, and sensor information about surroundings of the vehicle;
determining, based on a line of sight (LOS) condition being satisfied, one or more road boundaries, wherein the LOS condition being satisfied is determined based on the estimated position;
determining, based on a reference boundary, one of the one or more road boundaries as a filtering target;
setting, based on the filtering target, a driving distance by which the vehicle has traveled, periodically at an interval of a predetermined driving distance;
outputting a signal associated with the periodically set driving distance; and
controlling, based on the signal, autonomous driving of the vehicle.

20. The non-transitory computer-readable storage medium of claim 19, wherein the program, when executed, is configured to cause:
generating an LOS line, wherein the LOS line connects one point of one road boundary of the one or more road boundaries to the vehicle, and wherein the one point of the one road boundary of the one or more road boundaries is present within a sensor-perceivable area; and
determining whether the generated LOS line intersects another road boundary of the one or more road boundaries.
